(19) United States
(12) Patent Application Publication
(10) Pub. No.: US 2002/0125679 A1
(43) Pub. Date: Sep. 12, 2002

(54) Device disposed on a bicycle for generating an alerting light when the wheels of the bicycle rotate

(76) Inventor: Wu-Chung Jung, Yun-Lin Hsien (TW)

Correspondence Address: Morgan & Finnegan L.L.P, Maria C.H. Lin, 345 Park Avenue, New York, NY, 10154-0053, US

(21) Appl. No.: 09/801,311

(22) Filed: Mar. 7, 2001

(51) Int. Cl. B62K 3/00

(52) U.S. Cl. 280/288.4; 280/281.1

(57) ABSTRACT

An alerting-light generating device for a bicycle includes a light-generating wheel, which is connected pivotally to the bicycle frame and which has an outer periphery that contacts frictionally a rear wheel so as to rotate synchronously with the rear wheel. The light-generating wheel is adapted to generate an alerting light when rotating.

### CROSS REFERENCE TO RELATED APPLICATION

This application relates to commonly assigned copending application Ser. No. 09/691,602, filed on Oct. 18, 2000. This copending application is incorporated by reference herein.

### BACKGROUND OF THE INVENTION

1. Field of the Invention

This invention relates to a device for generating an alerting light in the dark, more particularly to an alerting-light generating device, which is disposed on a rear wheel of a bicycle and which generates an alerting light when the rear wheel rotates.

2. Description of the Related Art

Normally, a reflective plate is disposed on a rear portion of a bicycle for the purpose of drawing attention of people riding on moving vehicles behind the bicycle when the bicycle runs in the dark. However, when no light is emitted onto the reflective plate in the dark, it is difficult for people to be aware of the presence of the bicycle.

### SUMMARY OF THE INVENTION

An object of this invention is to provide a bicycle with a device for generating an alerting light in the dark when the wheels of the bicycle rotate.

According to this invention, an alerting-light generating device for a bicycle includes a light-generating wheel, which is connected pivotally to the bicycle frame and which has an outer periphery that contacts frictionally a rear wheel so as to rotate synchronously with the rear wheel. The light-generating wheel is adapted to generate an alerting light in the dark when rotating.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a schematic side view of a bicycle, which is provided with a first preferred embodiment of an alerting-light generating device according to this invention;

FIG. 2 is an exploded view of the first preferred embodiment;

FIG. 3 is an exploded view of a light-generating wheel of the first preferred embodiment;

FIG. 4 is a partly sectioned side view of the light-generating wheel of the first preferred embodiment;

FIG. 5 is a circuit diagram of a circuit provided in the light-generating wheel of the first preferred embodiment, in which a vibration trigger is at a closed state;

FIG. 6 is a schematic side view of a second preferred embodiment of an alerting-light generating device for a bicycle according to this invention;

FIG. 7 is a fragmentary top view of a connecting member of the second preferred embodiment;

FIG. 8 is an exploded view of a portion of a light-generating wheel of the second preferred embodiment;

FIG. 9 is a schematic sectional view of the light-generating wheel of the second preferred embodiment;

FIG. 10 is a schematic side view of a third preferred embodiment of an alerting-light generating device according to this invention;

FIG. 11 is a side view of a bicycle, which is provided with a fourth preferred embodiment of an alerting-light generating device for a bicycle according to this invention; and

FIG. 12 is a schematic side view of the fourth preferred embodiment.

### DETAILED DESCRIPTION OF THE PREFERRED EMBODIMENTS

Similar elements and structures are designated by like reference numbers throughout the whole disclosure.

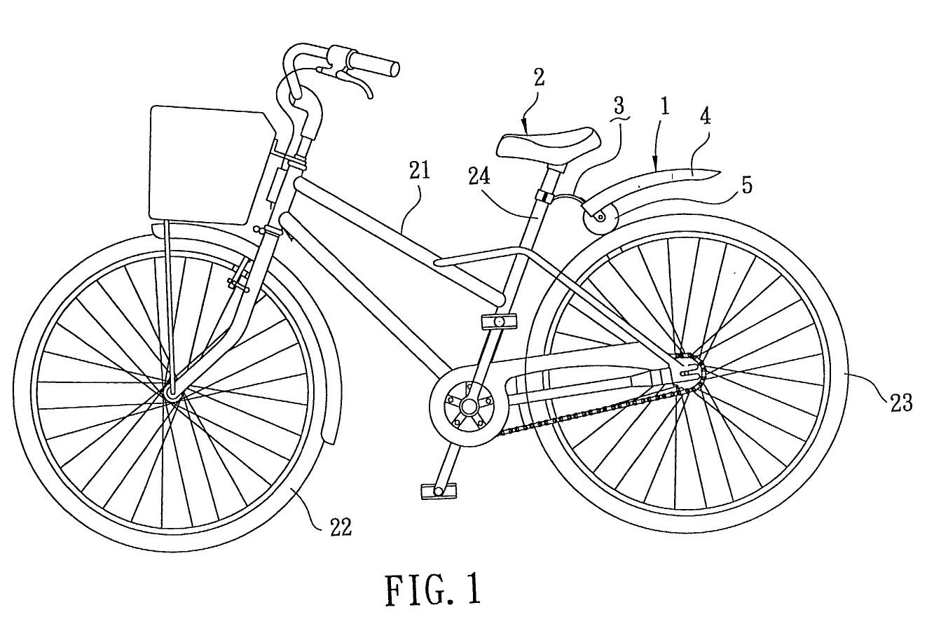

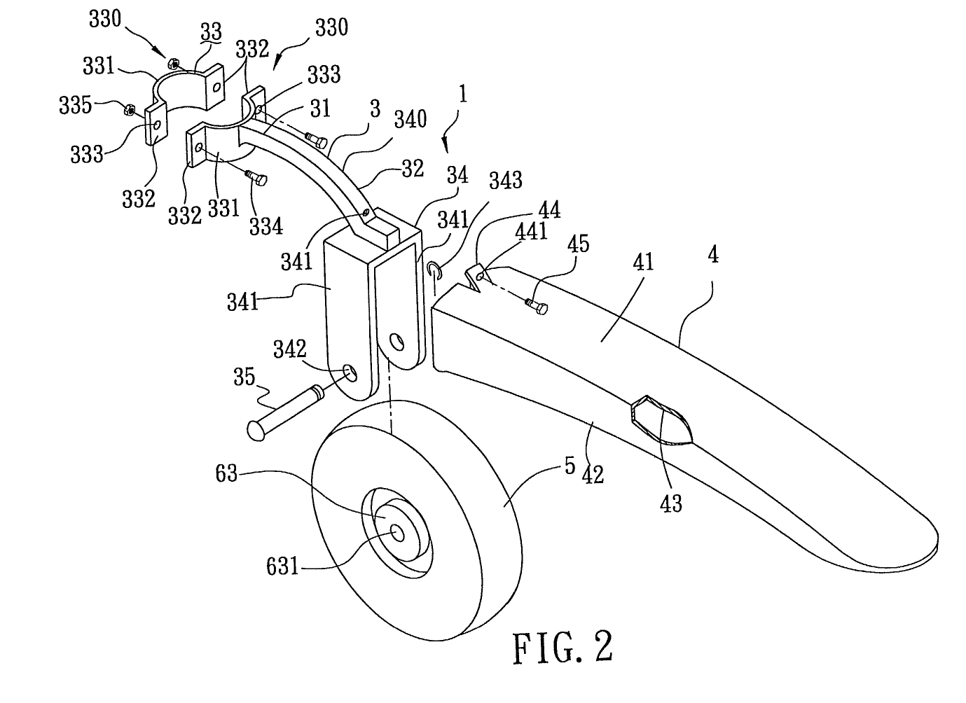

Referring to FIGS. 1 and 2, the first preferred embodiment of an alerting-light generating device 1 according to this invention is shown to be provided on a bicycle 2, which has a bicycle frame 21, a front wheel 22, a rear wheel 23, and a seat post 24. The device 1 includes a connecting member 3, a curved reflective member 4, and a light-generating wheel 5.

The connecting member 3 is made of a resilient material, and has a front end 31 and a rear end 32. The front end 31 is provided with a retaining ring 33 that includes front and rear ring halves 330. Each of the front and rear ring halves 330 has a semicircular post-clamping portion 331, two lugs 332 that project respectively and integrally from two ends of the post-clamping portion 331, and a fastener unit. The seat post 24 is clamped between the post-clamping portions 331 of the front and rear ring halves 331. Each of the lugs 332 has a hole 333 formed therethrough. The fastener unit includes two bolts 334 that extend respectively through the holes 333 in the lugs 332, and two nuts 335 that engage respectively the bolts 334, thereby interconnecting the front and rear ring halves 330 removably. The rear end 32 is provided with an inverted U-shaped element 34, which is connected fixedly to the rear ring half 330 by means of a curved rod 340 and which is formed with two parallel vertical side walls 341, each of which has a hole 342 for extension of a horizontal axle 35 therethrough. The axle 35 is retained on the inverted U-shaped element 34 by means of a C-shaped retaining ring 343. The light-generating wheel 5 is sleeved rotatably on the axle 35 between the side walls 341 of the inverted U-shaped element 34, and has an outer periphery, which contacts frictionally the rear wheel 23 so as to rotate synchronously with the same. The reflective member 4 has an elongated top plate 41, and a pair of vertical left and right side plates 42 that extend respectively, integrally and downwardly from two opposite sides of the top plate 41. Each of the left and right side plates 42 has a height, which reduces rearwardly and gradually. Each of the plates 41, 42 has an inner surface, which is formed with a reflective layer 43. The reflective member 4 has a front end, which is formed with an integral lug 44. A bolt 45 extends through a hole 441 in the lug 44 to engage a threaded hole 341 in the curved rod 340 of the connecting member 3, thereby fixing the reflective member 4 to the connecting member 3.

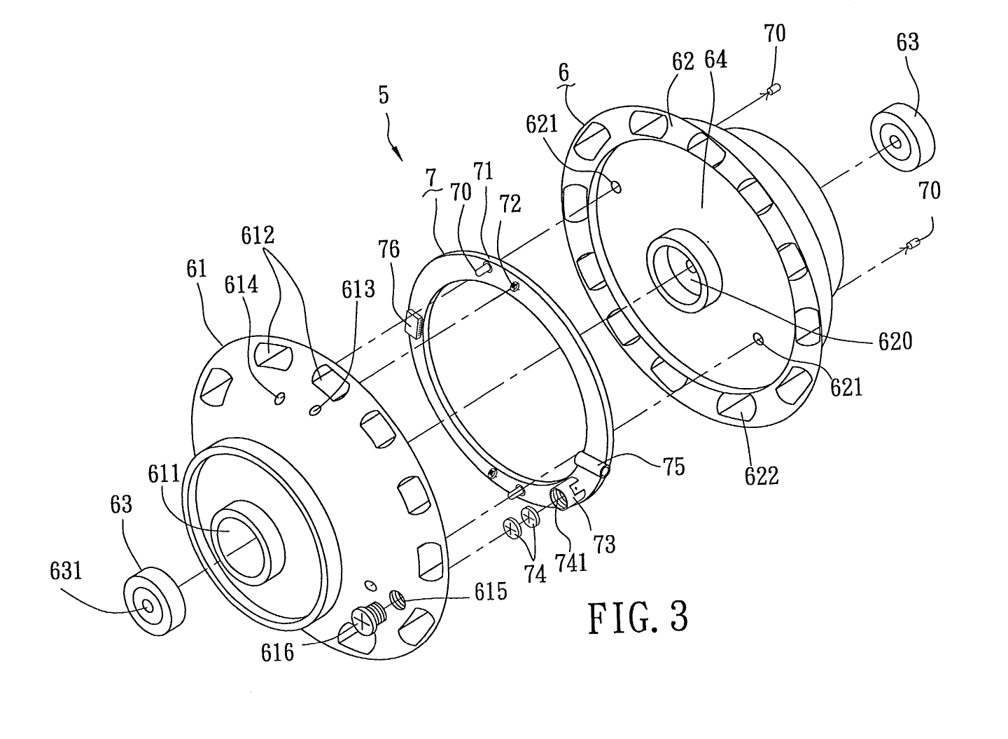

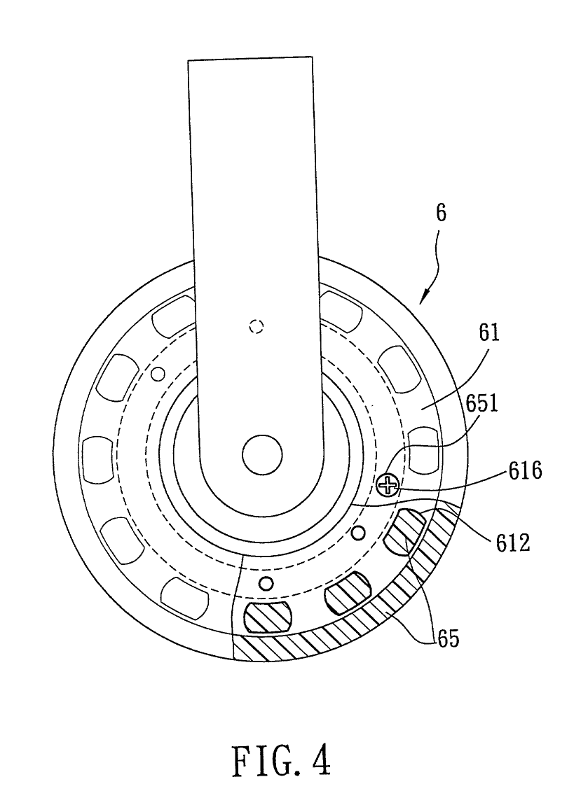

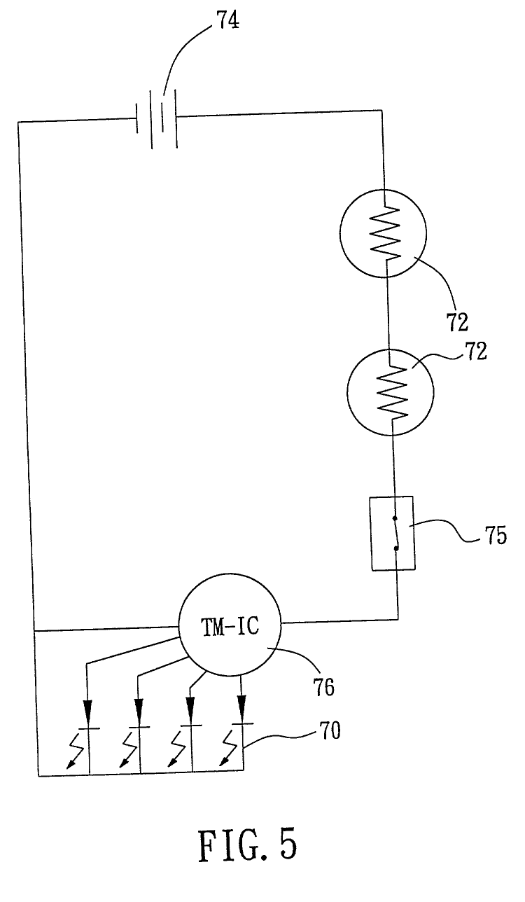

Referring to FIGS. 2, 3, 4, and 5, the light-generating wheel 5 includes a wheel body 6 and a circuit board 7 that is constructed as a ring. The wheel body 6 includes a pair of left and right wheel housings 61, 62, a pair of left and right bearings 63, an accommodating chamber defined between the left and right wheel housings 61, 62, and a molded rigid transparent ring 65 that surrounds the left and right wheel housings 61, 62 so as to fix the left and right wheel housings 61, 62 therein. The circuit board 7 is fixed within the accommodating chamber 64 in the wheel body 6, and is formed with a circuit, which includes four light emitting elements 70, two photosensitive resistors 72, a pair of batteries 74 confined within a threaded hole 741 in the circuit board 7, and a normally-open vibration trigger 75 that are interconnected in series. The vibration trigger 75 is adapted to be closed, as shown in FIG. 5, to allow passage of electrical current in the circuit therethrough only when the light-generating wheel 5 rotates. Two of the photosensitive resistors 70 are disposed on a left side surface of the circuit board 7, while another two are on a right side surface of the circuit board 7. The photosensitive resistors 70 are connected to the vibration trigger 75 by means of a timing integrated circuit board 76. Each of the photosensitive resistors 70 has a variable amount of resistance that is proportional to the luminosity of surrounding light around the bicycle 2. When the resistance of each of the resistors 70 is smaller than a preset value and when the vibration trigger 75 is closed, the light-emitting elements 70 emit an alerting light therefrom.

The left wheel housing 61 has a central hole 611, within which the left bearing 63 is received fittingly, a plurality of through holes 612 formed through an outer peripheral portion thereof, two resistor holes 613 for engaging respectively the resistors 72, two emitter holes 614 for engaging respectively the two light emitting elements 70 on the left side surface of the circuit board 7, a threaded battery hole 615, and a bolt 616 engaging the battery hole 615 and the threaded hole 741 in the circuit board 7 for preventing removal of the batteries 74 from the threaded hole 741. The axle 35 extends through central holes 631 in the bearings 63, thereby permitting rotation of the wheel body 6 relative to the axle 35. The right wheel housing 62 has a central hole 620, within which the right bearing 63 is received fittingly, a pair of emitter holes 621 that engage respectively the two light emitting elements 70 on the right side surface of the circuit board 7, and a plurality of through holes 622 that are formed therethrough and that are aligned with the through holes 612 in the left wheel housing 61. Because the rigid transparent ring 65 is made of a transparent material and is molded over the wheel housings 61, 62, it surrounds the same so that the through holes 612, 622 are filled with the transparent material, thereby fixing the wheel housings 61 therewithin.

Accordingly, the light-generating wheel 5 rotates synchronously with the rear wheel 23 so as to generate an alerting light in the dark.

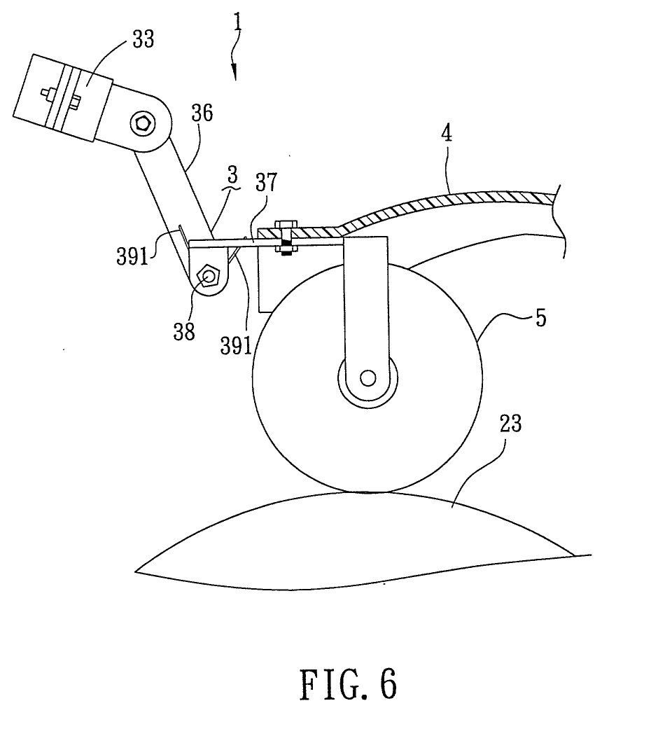

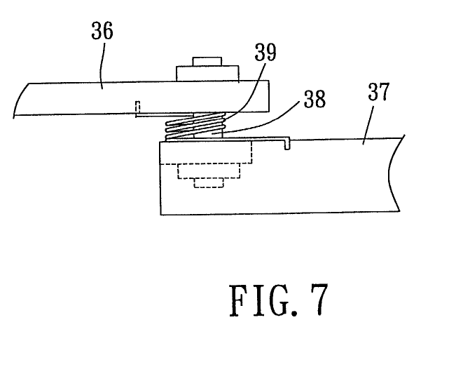

Referring to FIGS. 6 and 7, the second preferred embodiment of an alerting-light generating device 1 according to this invention also includes a connecting member 3, a curved reflective member 4, and a light-generating wheel 5. The connecting member 3 includes a rearwardly and downwardly inclined fixing rod 36, a generally horizontal swing rod 37, a pivot pin 38, and a coiled torsion spring 39. The fixing rod 36 has an upper end that is connected fixedly to the bicycle frame (not shown) by means of a retaining ring 33, which is similar to that of the first embodiment in construction. The swing rod 37 has a front end that is connected rotatably to the lower end of the fixing rod 36 by means of the pivot pin 38, and a rear end, on which the light-generating wheel 5 is mounted rotatably. The torsion spring 39 is sleeved on the pivot pin 38, and has two ends 391 that press respectively against the fixing rod 36 and the swing rod 37 for biasing a rear end of the swing rod 37 to turn downward, thereby pressing the light-generating wheel 5 against the rear wheel 23.

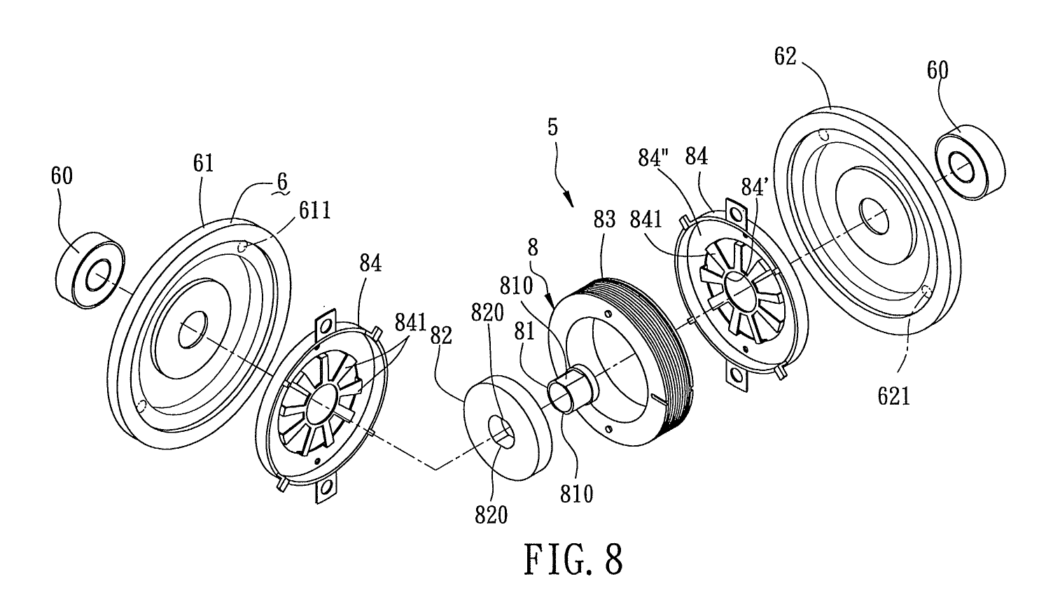

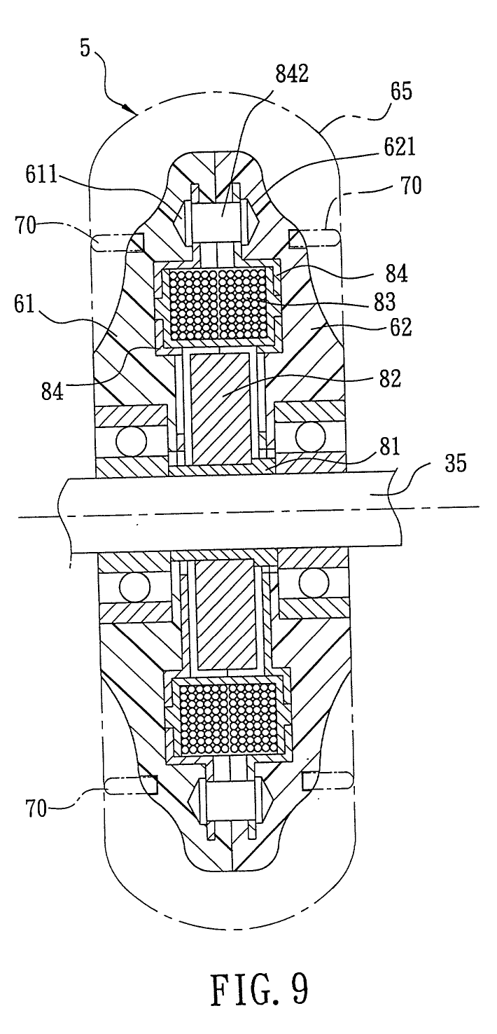

Referring to FIGS. 8 and 9, the light-generating wheel 5 of the second preferred embodiment includes an axle 35 disposed fixedly on the bicycle frame (not shown), a wheel body 6, a plurality of light-emitting elements 70, and an electromagnetic induction unit 8. Elements similar in construction to those shown in FIGS. 8 and 9 can be found in copending application Ser. No. 09/691,602.

The wheel body 6 is mounted rotatably around the axle 35 by means of bearings 60, and includes a pair of left and right wheel housings 61, 62, and a molded rigid transparent ring 65 that surrounds the left and right wheel housings 61, 62 so as to fix the left and right wheel housings 61, 62 therein.

The light-emitting elements 70 are disposed fixedly on the wheel body 6. The electromagnetic induction unit 8 includes a mounting tube 81, a ring-shaped permanent magnet 82, a coil 83, and a pair of ring-shaped vertical left and right magnetically conducting plates 84. The mounting tube 81 is formed with two opposed planar outer surfaces 810, which abut respectively against two planar inner surfaces 820 of the magnet 82, thereby permitting synchronous rotation of the magnet 82 and the axle 35. The coil 83 is disposed within the wheel body 6 around the magnet 82, and is in electrical connection with the light-emitting elements 70. The conducting plates 84 are mounted within the wheel body 6, and are coaxial with the magnet 82 and the coil 83. Each of the conducting plates 84 has an inner ring 84′, an outer ring 85″, and a plurality of elongated radially extending sheets 841 which are angularly spaced apart from each other and which are aligned with the magnet 82. The sheets 841 have radial inner ends that are formed integrally with the inner ring 84′, and radial outer ends that are formed integrally with the outer ring 84″. Two rivets 842 (see FIG. 9) interconnect the conducting plates 84 fixedly so as to clamp the coil 83 between the conducting plates 84,, and are inserted into cavities 621 in the left and right wheel housings 61, 62 so as to fix the conducting plates 84 relative to the wheel body 6, thereby permitting synchronous rotation of the coil 83, the conducting plates 84 and the wheel body 6.

When the wheel body 6 rotates about the axle 35, electricity is generated on the coil 83 so as to intermittently light up the light-emitting elements 70, thereby emitting a flashing light from the light-generating wheel 35.

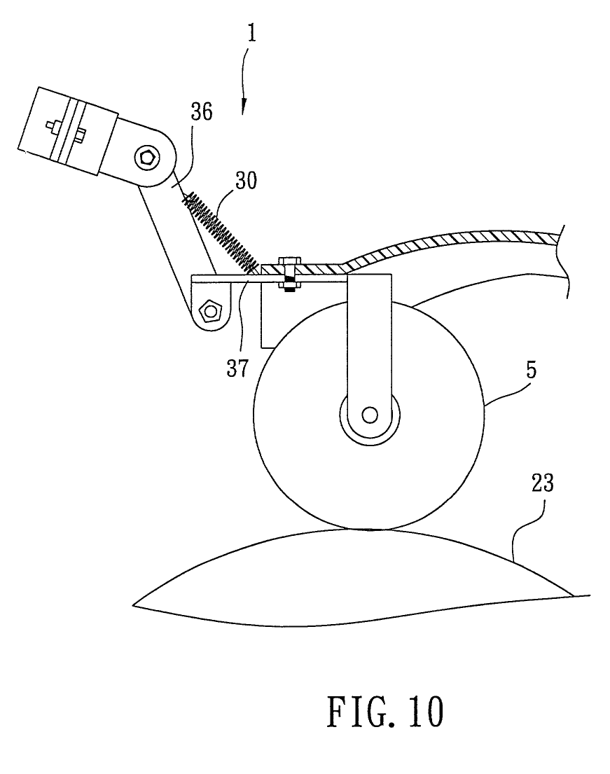

The torsion spring 39 can be replaced with a coiled compression spring 30 (see FIG. 10), which is disposed between the fixing rod 36 and the swing rod 37 and which has two ends that are fastened respectively to the upper end of the fixing rod 36 and the rear end of the swing rod 37, thereby biasing the swing rod 37 to turn downwardly relative to the fixing rod 36.

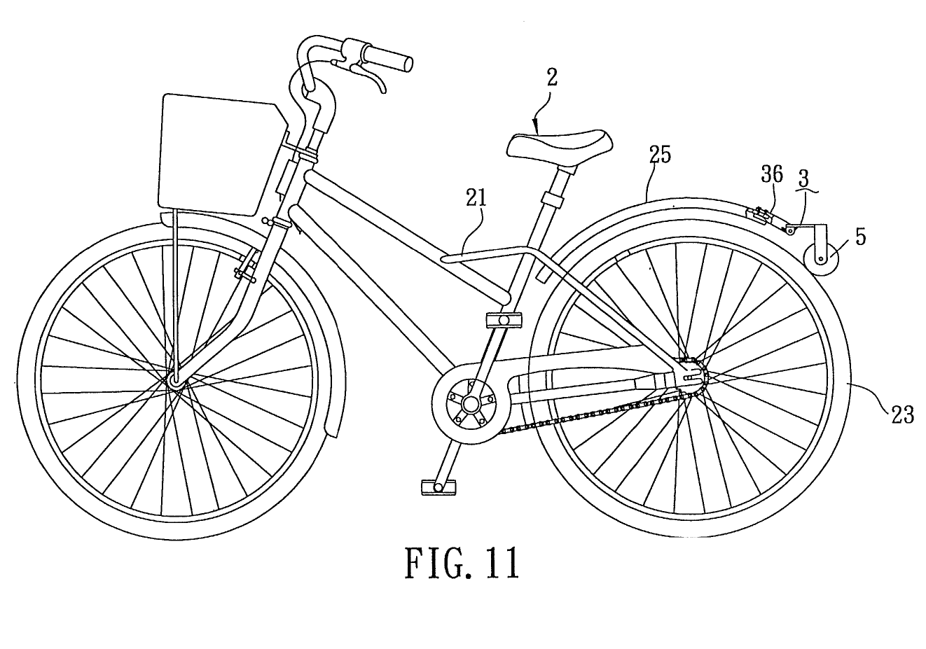

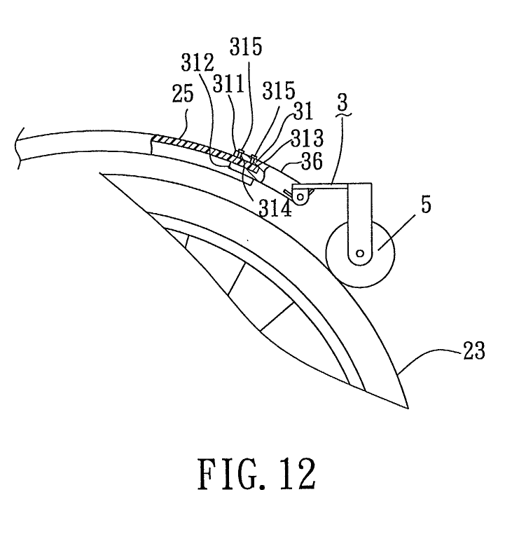

Referring to FIGS. 11 and 12, the bicycle frame 21 includes a fixed rear fender 25, which is disposed over the rear wheel 23. The front end 31 of the connecting member 3 is formed with a pair of integral upper and lower clamping plates 311, 312, which define a clamping space 313 therebetween. The fender 25 has a rear end, which is shaped as a horizontal plate and which is inserted into the space 313 between the upper and lower clamping plates 311, 312 of the connecting member 3. The upper clamping plate 311 is formed with two threaded holes 314 therethrough. Two lock bolts 315 engage respectively the threaded holes 314 in the upper clamping plate 311, and press against the rear end of the fender 25, thereby locking the connecting member 3 on the fender 25.

With this invention thus explained, it is apparent that numerous modifications and variations can be made without departing from the scope and spirit of this invention.

It is therefore intended that this invention be limited only as indicated in the appended claims.

I claim:

1. An alerting-light generating device for a bicycle, the bicycle including:
a bicycle frame having a front end and a rear end, and formed with a seat post;
a front wheel mounted rotatably on the front end of the bicycle frame; and
a rear wheel mounted rotatably on the rear end of the bicycle frame;
said alerting-light generating device comprising:
a connecting member; and
a light-generating wheel adapted to be connected pivotally to the bicycle frame by means of said connecting member and having an outer periphery, which is adapted to contact frictionally the rear wheel so as to be adapted to rotate synchronously with the rear wheel, said light-generating wheel being adapted to generate an alerting light when rotating.

2. The alerting-light generating device as claimed in claim 1, wherein said connecting member has a front end, which is provided with a retaining ring that includes a front ring half and a rear ring half, each of said front and rear ring halves having a semicircular post-clamping portion, two lugs that project respectively and integrally from two ends of said post-clamping portion, and a fastener unit, said post-clamping portions of said front and rear ring halves being adapted to clamp the seat post therebetween, each of said lugs having a hole formed therethrough, said fastener unit including two bolts that extend respectively through said holes in said lugs, and two nuts that engage respectively said bolts, thereby interconnecting said front and rear ring halves removably.

3. The alerting-light generating device as claimed in claim 1, wherein said connecting member includes:
a rearwardly and downwardly inclined fixing rod having an upper end that is adapted to be connected fixedly to the bicycle frame, and a lower end;
a pivot pin; and
a generally horizontal swing rod having a front end that is connected rotatably to said lower end of said fixing rod by means of said pivot pin, and a rear end, on which said light-generating wheel is mounted rotatably.

4. The alerting-light generating device as claimed in claim 3, wherein said connecting member further includes a coiled torsion spring, which is sleeved on said pivot pin and which biases said rear end of said swing rod to turn downward, thereby pressing said light-generating wheel against the rear wheel.

5. The alerting-light generating device as claimed in claim 3, wherein said connecting member further includes a coiled compression spring, which is disposed between said fixing rod and said swing rod and which has two ends that are fastened respectively to said upper end of said fixing rod and said rear end of said swing rod, thereby biasing said swing rod to turn downwardly relative to said fixing rod.

6. The alerting-light generating device as claimed in claim 1, further comprising a curved reflective member, which has an elongated top plate, and a pair of vertical left and right side plates that extend respectively, integrally and downwardly from two opposite sides of said top plate, each of said left and right side plates having a height, which reduces rearwardly and gradually.

7. The alerting-light generating device as claimed in claim 6, wherein each of said top plate and said left and right side plates has an inner surface, which is formed with a reflective layer.

8. The alerting-light generating device as claimed in claim 1, wherein said light-generating wheel includes:
a wheel body including a pair of left and right wheel housings, an accommodating chamber defined between said left and right wheel housings, and a molded rigid transparent ring that surrounds said left and right wheel housings so as to fix said left and right wheel housings therein; and
a circuit board fixed within said accommodating chamber in said wheel body and formed with a circuit, which includes a light emitting element, a photosensitive resistor, a battery, and a normally-open vibration trigger that are interconnected in series, said vibration trigger being adapted to be closed to allow passage of electrical current in said circuit therethrough only when said light-generating wheel rotates, said photosensitive resistor having a variable amount of resistance that is proportional to luminosity of surrounding light around the bicycle, said light emitting element emitting light therefrom when the resistance of said photosensitive resistor is smaller than a preset value and when said vibration trigger is closed.

9. The alerting-light generating device as claimed in claim 1, wherein said light-generating wheel includes:
an axle adapted to be disposed fixedly on the bicycle frame;
a wheel body sleeved rotatably on said axle and including a pair of left and right wheel housings, an accommodating chamber defined between said left and right wheel housings, and a molded rigid transparent ring that surrounds said left and right wheel housings so as to fix said left and right wheel housings therein;
a plurality of light-emitting elements disposed fixedly on said wheel body; and
an electromagnetic induction unit including a ring-shaped permanent magnet that is sleeved fixedly on said axle, a coil that is disposed fixedly within said wheel body around said magnet and that is in electrical connection with said light-emitting elements, and a pair of ring-shaped vertical left and right magnetically conducting plates that are mounted fixedly within said wheel body and that are coaxial with said magnet and said coil, each of said conducting plates having an inner ring, an outer ring, and a plurality of elongated radially extending sheets which are angularly spaced apart from each other and which are aligned with said magnet, said sheets having radial inner ends that are formed integrally with said inner ring, and radial outer ends that are formed integrally with said outer ring;
whereby, when said wheel body rotates about said axle, electricity is generated on said coil so as to intermittently light up said light-emitting elements, thereby emitting a flashing light from said light-generating wheel.

10. An alerting-light generating device for a bicycle, the bicycle including:
a bicycle frame having a front end and a rear end, and formed with a rear fender;
a front wheel mounted rotatably on the front end of the bicycle frame; and
a rear wheel mounted rotatably on the rear end of the bicycle frame and disposed under the rear fender;
said alerting-light generating device comprising:
a connecting member; and
a light-generating wheel adapted to be connected pivotally to the bicycle frame by means of said connecting member and having an outer periphery, which is adapted to contact frictionally the rear wheel so as to be adapted to rotate synchronously with the rear wheel, said light-generating wheel being adapted to generate an alerting light when rotating, wherein said front end of said connecting member is formed with a pair of integral upper and lower clamping plates, one of which is formed with two threaded holes therethrough, said fender having a rear end, which is shaped as a horizontal plate and which is inserted between said upper and lower clamping plates of said connecting member, said connecting member further including two lock bolts, which engage respectively said threaded holes in said one of said upper and lower clamping plates and which press against said rear end of said fender, thereby locking said connecting member on said fender.
